(19) United States
(12) Patent Application Publication
(10) Pub. No.: US 2007/0116056 A1
(43) Pub. Date: May 24, 2007

(54) Digital subscriber line access sharing method and device

(75) Inventors: Rene L. Cruz, La Jolla, CA (US); Huseyin Cahit Akin, San Diego, CA (US); Rajesh Mishra, San Diego, CA (US)

Correspondence Address: GREER, BURNS & CRAIN, 300 S WACKER DR, 25TH FLOOR, CHICAGO, IL, 60606, US

(73) Assignee: The Regents of the University of California

(21) Appl. No.: 11/546,208

(22) Filed: Oct. 11, 2006

Related U.S. Application Data
(63) Continuation-in-part of application No. 10/583,435, filed on Jun. 16, 2006.
(60) Provisional application No. 60/726,021, filed on Oct. 12, 2005.

(51) Int. Cl. H04H 1/04

(52) U.S. Cl. 370/487; 370/493

(57) ABSTRACT

A method of sharing digital subscriber line resources is provided by the invention. In a digital subscriber line (DSL) communication system including a central office connected to customer premises over telephone lines, a resource sharing method includes establishing a LAN (local area network) network through a junction box shared by a plurality of customer premises. LAN communications are used to coordinate sharing of DSL resources provided from a central office to the junction box. The DSL data bandwidth provided to the junction box from the central office is shared by the customers in the LAN. Methods of the invention can be carried out with a junction box or junction box modifications. A junction box has resources provided from a central office and connects to customer premises. A resource sharing junction box of the invention provides aggregated communication channels to enable resource sharing of a plurality of customer telephone lines for resource sharing. Connectors connect the junction box to a plurality of customer premises. Networking DSL modems of the invention are able to communicate via a LAN provided by the junction box to achieve resource sharing of the bandwidth provided to the junction box.

### PRIORITY CLAIM AND REFERENCE TO RELATED APPLICATION

This application is related to and claims priority under 35 U.S.C. §119 from prior provisional application Ser. No. 60/726,021, filed Oct. 12, 2005; and is a continuation-in-part of and claims priority under 35 U.S.C. §120 from prior utility application Ser. No. 10/583,435, filed Dec. 19, 2003 and entitled RESOURCE SHARING BROADBAND ACCESS SYSTEM, METHODS, AND DEVICES

### FIELD

A field of the invention is network communications, including Internet and intranet communications. The invention concerns methods and devices permitting digital subscriber lines to be shared among customers, thereby enabling faster communications for applications such as Internet access.

### BACKGROUND OF THE INVENTION

Dial-up service is a common method of Internet access. Dial-up service uses a dial-up modem through which a computer makes phone calls to an Internet service provider. The dial-up modem transforms digital data from the personal computer into an analog signal for transmission through a phone line, and conversely converts incoming analog signals into digital data for the personal computer. Dial-up service is known to be slow. For example, viewing web pages with multimedia content, such as graphical images, is often unacceptably slow.

Broadband access addresses this problem by providing higher digital data rates than dial-up service. A “DSL” (Digital Subscriber Line) involves upgrading the dial-up modem to a higher speed modem, known as a DSL modem, as well as using an upgraded modem device at the Internet Service Provider (ISP) premises, also known as the “central office.” The DSL approach uses existing copper wire, possibly upgraded along certain segments to increase its capacity to carry digitized information. The DSL data is carried over the same telephone line that is already connected to the customer location, such as a business or a residential unit, and the central office that is owned and operated by the local telephone company. The DSL data is carried over a different frequency band than used for voice communications. The data rates achievable by DSL are dependent on the distance between the customer location and the central office, and commonly range roughly between 100 kbps-1500 kbps. A DSL connection is commonly called a broadband access line.

Another broadband access scheme most commonly used with residential customers makes use of the coaxial cable that passes through a residential unit, for purposes of providing television signals to the home, “Cable TV”. A specialized modem, called a cable modem, is attached the coaxial cable inside the residential unit. The cable modem facilitates digital communication between the residential unit and facilities owned by the cable TV operator (often called a “Multiple Services Operator”(MSO)). The MSO is attached to the Internet, and thus becomes an Internet service provider for the residential unit. The coaxial cable entering a residential unit is typically shared with other residential units in close geographic proximity. Currently, peak data rates on the order of approximately 5 to 10 million bits per second (Mbps) are commonly obtained with cable modems. Peak data rates available with cable modem technology are commonly greater than that with DSL modem technology.

### SUMMARY OF THE INVENTION

A method of sharing digital subscriber line resources is provided by the invention. In a digital subscriber line (DSL) communication system including a central office connected to customer premises over telephone lines, a resource sharing method includes establishing a LAN (local area network) network through a junction box shared by a plurality of customer premises. LAN communications are used to coordinate sharing of DSL resources provided from a central office to the junction box. The DSL data bandwidth provided to the junction box from the central office is shared by the customers in the LAN.

Methods of the invention can be carried out with a junction box or junction box modifications. A junction box has resources provided from a central office and connects to customer premises. A resource sharing junction box of the invention provides aggregated communication channels to enable resource sharing of a plurality of customer telephone lines for resource sharing. Connectors connect the junction box to a plurality of customer premises. Networking DSL modems of the invention are able to communicate via a LAN provided by the junction box to achieve resource sharing of the bandwidth provided to the junction box.

### BRIEF DESCRIPTION OF THE DRAWINGS

FIG. 1 is a block diagram of a residential broadband access system in accordance with an embodiment of the invention;

FIG. 2 is a schematic illustrating wiring in a typical conventional junction box of a residential broadband access system in a legacy system;

FIG. 3 is a block diagram of a hub junction device of the invention used to modify a conventional junction box like that shown in FIG. 2 for use in a preferred embodiment;

FIG. 4 is a frequency allocation plan for signals on twisted copper wire pairs, in accordance with a hub mode of an embodiment of the invention;

FIG. 5 is a block diagram of an DSL modem in accordance with a hub mode of an embodiment of the invention;

FIG. 6 is a block diagram of a switch junction device for use in the system of FIG. 1 to support a switch mode of the invention;

FIG. 7 is a block diagram of another DSL modem in accordance with a hub mode of an embodiment of the invention.

### DETAILED DESCRIPTION

The invention concerns methods, systems and devices for sharing Digital Subscriber Line (DSL) communication resources. A method of sharing digital subscriber line resources is provided by the invention. In a digital subscriber line (DSL) communication system including a central office connected to customer premises over telephone lines, a resource sharing method includes establishing a LAN (local area network) network through a junction box shared by a plurality of customer premises. LAN communications are used to coordinate sharing of DSL resources provided from a central office to the junction box. The DSL data bandwidth provided to the junction box from the central office is shared by the customers in the LAN.

Methods of the invention can be carried out with a junction box or junction box modifications. A junction box has resources provided from a central office and connects to customer premises. A resource sharing junction box of the invention provides aggregated communication channels to enable resource sharing of a plurality of customer telephone lines for resource sharing. Connectors connect the junction box to a plurality of customer premises. Networking DSL modems of the invention are able to communicate via a LAN provided by the junction box to achieve resource sharing of the bandwidth provided to the junction box.

An embodiment of the invention, for example, establishes a local area network over existing copper wires between customers, in order to share DSL lines. In preferred embodiments, a DSL junction box and networking DSL modems facilitate the pooling together of separate customer DSL lines, and customers then share the pooled DSL lines. Customers are thereby provided with an access medium that has a larger capacity to transport bursts of data than that provided by the DSL line of a single customer.

Systems, methods, and devices of the invention enable legacy DSL communication resources to be aggregated with a junction box that facilitates resource sharing of a plurality of DSL customers. Embodiments of the invention provide higher peak data transfer rates to end-users than legacy DSL communications. In a preferred embodiment, the DSL resources that are aggregated are the copper wire based communication channels that exists between a junction box and the central office.

In one embodiment of the invention, called hub mode, a hub junction device creates a local area network between DSL modems connected to the junction box. The local area network facilitates sharing of the legacy DSL resources. The hub junction device can be implemented with either passive or active electronic devices.

In another embodiment of the invention, called switch mode, a switch junction device interconnects DSL modems at customer premises. Legacy DSL communication resources are also used between the junction box and the central office. A processor associated with the switch junction device dynamically aggregates and shares DSL resources of interconnected modems.

Embodiments of the invention provide, for example, a shared access broadband access system serving a plurality of DSL customers, e.g., residences or businesses. In preferred embodiments, a DSL junction box and networking DSL modems facilitate the pooling together of separate customer DSL customer lines, and customers then share the pooled DSL lines. Customers are thereby provided with an access medium that has a larger capacity to transport bursts of data than that provided by the DSL line of a single customer. Customers are provided with shared broadband access. The performance of existing wired broadband access can be significantly improved with the invention.

In preferred embodiments of the invention, customers are residential units, such as houses or apartments, and in other embodiments, customers are business units, such as a plurality of leased offices in a building or a number of buildings. In some embodiments, a server may be part of the customer community, for example to act as a proxy server and/or provide a baseline level of wired network access by one or more broadband connections. This baseline connection to the wired network is then enhanced by shared DSL resources.

Networking DSL modems of the invention can communicate with any protocol that permits customers in the community to route packets among the shared DSL resources. Customers are typically geographically co-located, and make use of common DSL junction box. Typically, and in preferred embodiments, this will be a close geographical arrangement, such as within a business park, in an office building or group of buildings with a number of business units (e.g., different firms or companies), or in a neighborhood of residential units.

Embodiments of the invention include networking DSL modem devices or software resident within or connected to a customer computer. The device or software implements a protocol to communicate with other like devices or software connected to other DSL customers that are part of a common shared DSL resource community. The device or software is able to identify packets from different sessions, and can assign sessions to customers with an Internet connection. The software directs packets transmitted from customers over one or more DSL lines in the DSL community, and forwards packets received from the DSL lines and belonging to a session to the customer with an Internet connection, using the protocol. In a preferred embodiment, the device or software is implemented in a DSL modem. In other exemplary embodiments it is implemented in a router or device connected to a DSL modem. Encryption can be provided by the device or software to protect customer sessions from other customers in the shared DSL community.

Preferred embodiments where customers are residential units will now be discussed, while artisans will appreciate broader aspects of the invention from their description. In addition, a residential unit may, for example, include multiple DSL lines, while the description assumes one DSL line per unit for simplicity of explanation. Customers can exploit the bursty nature of data traffic generated by community members.

In particular, in a local neighborhood of residential units, it is unlikely that all residential unit customers are using their Internet access lines at the same time. The idle capacity of the DSL line of customers in a shared DSL community can be used to support the data transfer requests of an active customer in the shared DSL community. DSL lines in a shared DSL community are thus pooled together and shared, creating the capability for an individual customer to avail itself of the transmission capacity in all DSL lines of the shared DSL resource community. This will improve the speed of Internet access, for example web browsing, without requiring an upgrade of existing DSL lines.

In a DSL resource sharing community, a networking DSL modem or a separate device outside of a customer in the community acts as a proxy server to append information necessary for packet routing to and from customers. The proxy server can establish a communication session with a network resource, e.g., a server on the Internet, on behalf of customers in the shared resource DSL community.

Preferred embodiments will now be discussed with reference to the drawings. Schematic illustrations will be understood by artisans with reference to description. Artisans will also recognize broader aspects of the invention from the description of the preferred embodiments.

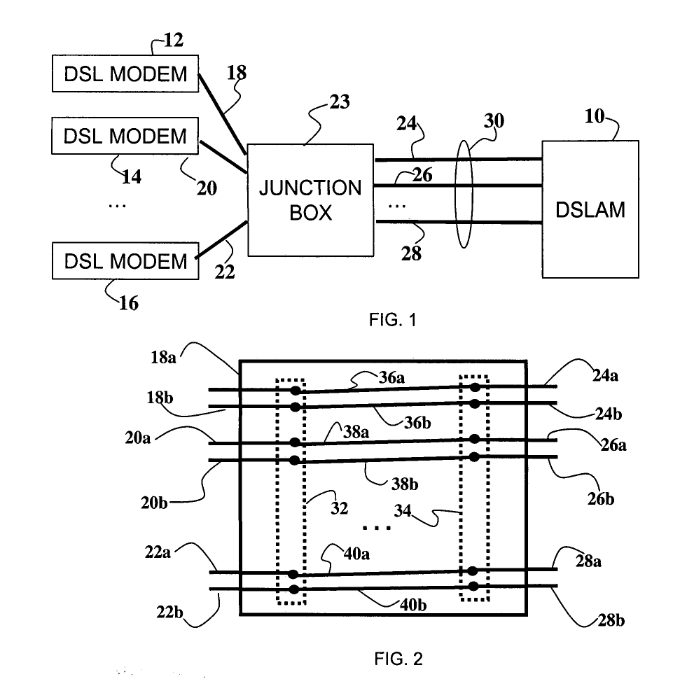

A DSL access system is illustrated in FIG. 1. A DSL Access Multiplexer (DSLAM) device 10 at a central office communicates with networking DSL modems 12, 14, 16 within residential units through twisted wire pairs 18, 20, 22, that connect to a junction box 23. The junction box 23 is connected to the DSLAM device at the central office with additional twisted wire pairs 24, 26, 28, that are run from the central office to the residential units. This same copper wire is used to carry voice telephone communications, and a designated frequency band is used for data communications between the DSLAM 10 and DSL modems 12, 14, 16. For Internet access applications, for example, the DSLAM 10 has a connection to the Internet, thereby enabling Internet access for customers through the DSL modems 12, 14, 16. Wiring in legacy systems typically has twisted wire pairs of copper wire between the central office and the junction box 23 near customer premises organized into cable bundles 30, which facilitate maintenance. Signals are routed through connections in the junction box 23.

FIG. 2 schematically illustrates typical wiring inside a conventional junction box. Common reference numbers from FIG. 1 are used to illustrate the wire pairs, which are shown separately in FIG. 2. Thus, the wire pair 12 in FIG. 1 is illustrated with its separate wires 12a and 12b in FIG. 2. The junction box 23 includes wiring connectors 32 and 34 that provide options for routing wires in the cable bundle 30 to different customers. Typically, a junction box includes connections for 25 or more pairs, and interconnecting wire pairs 36a and 36b, 38a and 38b, and 40a and 40b between the wiring connectors 32 and 34 determine which cables from the bundle 30 are connected to which customer premises.

DSL is implemented in legacy wiring of telephone systems based upon the connections between customers and the central office. A customer, for example, having wire pair 18a and 18b has its voice and data signals run through interconnecting wires 36a and 36b, and to the DSLAM 10. For DSL communications, the DSLAM 10 at the central office multiplexes frequencies for voice and data. Voice communications use a single band for communications in both directions, while DSL uses another band, typically divided into sub-bands allocated separately to outgoing and incoming communications.

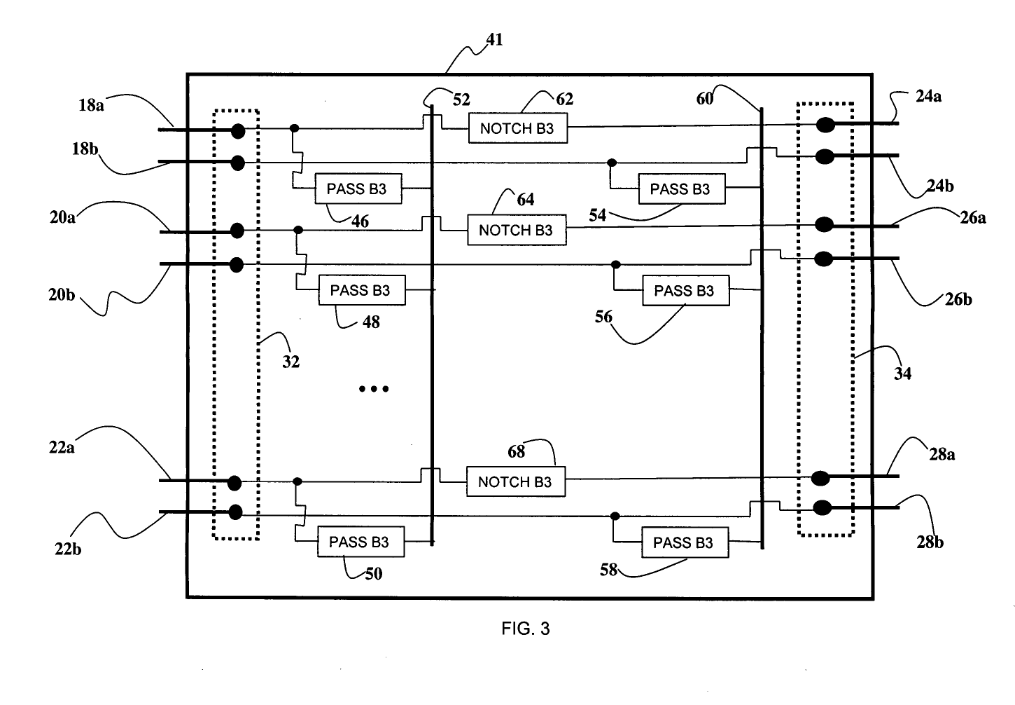

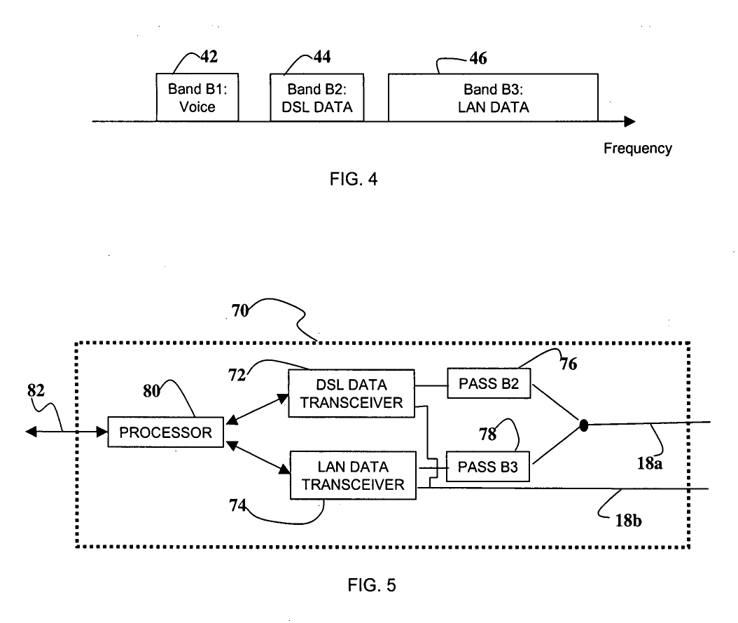

FIG. 3 illustrates a modified junction box 41 for implementing DSL resource sharing in accordance with the invention using an additional frequency for communications between DSL customers with resource sharing capability. Typical voice and data bands are shown in FIG. 4 with an additional higher frequency band 46 established in methods and systems of the invention to permit the DSL modems 12, 14 and 16 to communicate, such as by LAN network communication protocols, to achieve resource sharing of the wires in the cable bundle 30. Faster data communications between the central office and customer premise locations are provided by pooling and statistically sharing copper wire pairs in the cable bundle 30. Preferred embodiments of the invention are implemented by modifying existing portions of existing DSL systems. The invention can be implemented in presently used DSL systems with modifications to the systems. In a preferred embodiment of the invention referred to as a hub mode, wiring inside a junction box such as the junction box 23 in FIG. 2 is modified with filters and connections to create a hub junction device. In another preferred embodiment of the invention referred to as a switch mode, a switch junction replaces the wiring and connections in a junction box.

In preferred embodiments, all of the wiring pairs from one or more cable bundles connected to a junction box are made available for sharing data communications whether or not they are assigned to a particular customer for voice and/or data services. In other embodiments, only those wire pairs routed into a junction box from the DSLAM 10 that are assigned to a customer account are used for networked DSL resource sharing in accordance with the invention.

The preferred filtering arrangement for the modified junction box 41 in FIG. 3 permits the networked communications for resource sharing. The filters establish the LAN DATA band B3 46, and enable the resource sharing communications without interrupting normal legacy DSL and voice functions. The junction box 41 can be a replacement junction box in a legacy system, or could be a box that has been rewired and had filters added and properly connected. Using the additional LAN DATA band B3, the networking DSL modems 12, 14 and 16 can communicate with each other to achieve resource sharing.

In a preferred embodiment, to communicate information from one networking DSL modem to another, a first networking DSL modem places a signal within the frequency band B3. This signal propagates to the junction box 41. In this example, the signal will assumed to original from the networking DSL modem 12, which places signals on the pair 18a, 18b. In the junction box 41, pass-band filter 48 passes frequency band B3 46 signals. Additional pass band filters 48, 50 perform and are connected like the pass band filter 48. The pass-band filters are realized, for example, with a two port electrical circuit with a relatively small impedance for frequencies within the frequency band B3 46 and a relatively large impedance for frequencies outside the frequency band B3 46.

The pass band filters 46, 48, 50 are connected to one of the wires in each of the twisted pairs and also to a common junction 52, which can be realized with an additional wire. The other wires of the twisted pairs connected to pass band filters 54, 56, 58, which connect to a common junction 60. Effectively, for signals within the frequency band B3 46, the network of pass-band filters in the junction box 41 causes the twisted pairs to be connected in parallel. A filtered signal from one networking modem within frequency band B3 46 to the junction box 41 is broadcast back to other customers having networking modems served by the same junction box 41. The networking DSL modems may use a Media Access Control (MAC) protocol to control transmissions by different networking DSL modems, so they do not interfere with each other.

Notch filters 62, 64, 68 attenuate frequency band B3 46 signals so that those signals meant for resource sharing LAN communications are substantially blocked from propagating toward the DSLAM 10 at the central office. The notch filters in preferred embodiments are also a two port electrical circuit that has a relatively high impedance in frequency band B3 46. For frequencies outside the frequency band B3 46, the notch filters have a relatively low impedance. The notch filters pass frequency band B1 42 for voice and frequency band B2 44 for DSL data.

Artisans will appreciate that the physical distance between the junction box 41 and the central office is typically much larger than the physical distance between the junction box and the customer premises. As a result, the higher frequency band B3 46 for LAN communications to enable DSL resource sharing can be implemented even if it has higher attenuation per unit length of wire than normally acceptable for communications between customer premises and the central office.

Artisans will also appreciate that the hub junction device can be implemented either with a passive circuit design or an active circuit design. A passive design has the advantage of being potentially lower cost and higher reliability, but may have less than ideal transmission characteristics as specified above. For example, a pass-band filter can be implemented by a series connection of a capacitor and an inductor. A notch filter can be implemented by connecting an inductor, a capacitor, and a resistor, in parallel. Higher order filters can be used to improve the transmission characteristics as necessary.

An active circuit design for hub junction can generally be designed with almost ideal transmission characteristics, and may be physically smaller, but requires a power supply. Power could be delivered through one or more of the twisted pairs 24, 26, 28 from the central office to the junction box 41, as is done for legacy voice communications. Artisans will recognize many specific hardware implementations to implement a hub junction device in accordance to carry out the functionality of the example FIG. 3 embodiment.

Hub junctions of the invention can be flexibly configured to provide LAN connectivity only to a subset of the customers who share a common junction box, in accordance with their subscription to the networking DSL service. Accordingly, the enhancements provided by embodiments of the invention can be implemented by subscriptions with attendant charges. The pass band filters 46, 48, 50, 54, 56, 58 can be selectively be connected or disconnected in order to achieve this.

Hub Mode

A networking DSL modem 70 that operates in the context of the hub mode of the invention is illustrated in FIG. 5. The DSL modem can be implemented in hardware, firmware or software, and can be a stand alone device or devices, can be a plug-in or accessory device to a mode, can be implemented in a computer, etc.

The networking DSL modem 70 includes a DSL data transceiver 72 and a LAN data transceiver 74. Signals transmitted by the DSL transceiver 72 are joined with signals transmitted by the LAN transceiver through band-pass filters 76, 78 that respectively pass the DSL band B2 44 and the LAN band B3 46. The transceivers 72 and 74 are controlled by a processor 80.

Voice signals in frequency band B1 42 are passed normally through the junction box 41 from the customer premises to the central office. Similarly, voice signals in the frequency band B1 42 are passed normally through the junction box 41 from the central office to the customer premises. This includes DC power and control signals used to facilitate voice communications. Legacy DSL communication signals in the frequency band B2 44 re passed normally through the junction box 41 from the customer premises to the central office. Similarly, legacy DSL communication signals in the frequency band B2 44 re passed normally through the junction box 41 from the central office to the customer premises.

A networking DSL modem device of the invention includes two remote bi-directional communication channels, one for communicating with the DSLAM 10 at the central office, and another for communicating with other networking DSL modem devices connected to the same cable bundle that is terminated at a common junction box. To enhance the system performance, the networking DSL modem can facilitate the dynamic use of all DSL communication resources terminating at the junction box for a single user within the premises of a single customer.

The HUB mode embodiment establishes a local area network that permits resource sharing among DSL customers that have the networking services provided by the invention. Preferred mechanisms and techniques for the resource sharing are disclosed in 10/583,435, filed Dec. 19, 2003 and entitled RESOURCE SHARING BROADBAND ACCESS SYSTEM, METHODS, AND DEVICES, which is incorporated by reference herein. In the present invention, a local network is created for resource sharing. In that application, a wireless community network is used. The resource sharing methods used in the wireless community are preferably applied by networking DSL modems of the present invention. For example, when a download request is sent by a customer to a networking DSL modem through a customer interface 82, the processor 80 will intercept the request, and potentially redirect the request through another networking DSL modem, via the local area network established by the hub junction. In this way, load is dynamically shared among all the DSL lines running between the central office and the junction box, and higher peak data transfer rates are possible.

Artisans will also appreciate that even though the original wiring of a legacy system junction box is modified or replaced, an additional reconfigurable connector can also be added to the junction box, to retain the re-configurability that the junction box provided in the first place. Also, rather than having a single LAN for all networking DSL modems connected to the same junction box, the networking DSL modems can be partitioned into separate smaller groups and separate LANs can be established for each group.

Switch Mode

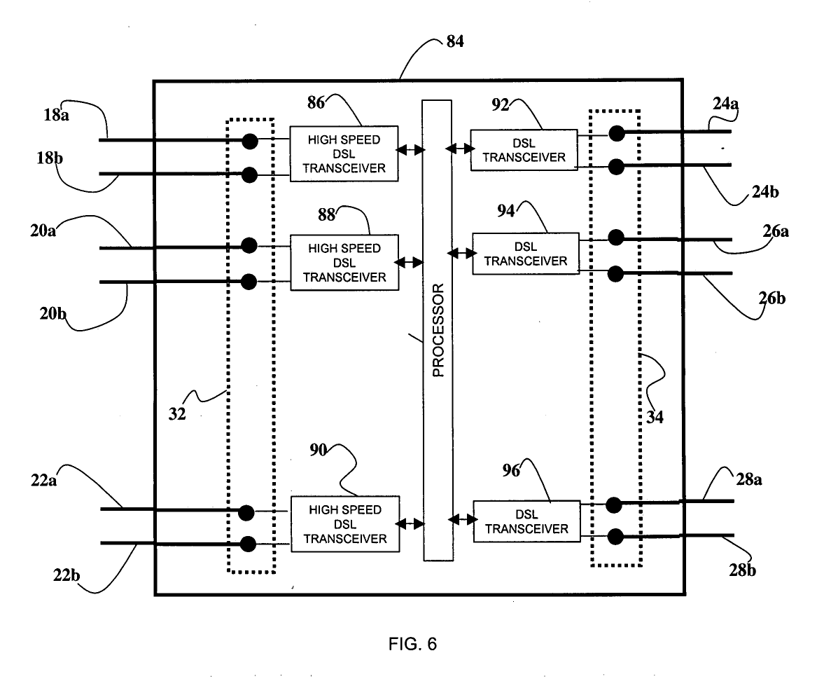

Another embodiment of the invention is referred to as a switch mode. In this embodiment, the wiring inside a junction box is replaced by a switch junction device 84, such as illustrated in FIG. 6. A standard DSL modem can be used with a switch mode junction device of the invention to achieve resource sharing in accordance with the invention. In this mode, the networking DSL modems 12, 14, 16 use legacy DSL band B2 44 to communicate with the switch junction device. Since the distance between the distance between the customer premises and the junction box is limited, LAN resource sharing communications on the legacy DSL band B2 44 can be at significantly higher speed than the legacy DSL data transfer.

The switch junction device 84 includes high speed DSL transceivers 86, 88, and 90, which operate at significantly higher data rates than legacy DSL transceivers 92, 94, 96. A processor 98 uses the data rate mismatch to achieve dynamic sharing and aggregating of the legacy DSL bandwidth provided to the junction box 84 by the cable bundle 30 and DSLAM 10. Such aggregation can be implemented in several ways. In one embodiment, the aggregation can be achieved by a multi-link protocol, such as PPP.

Resource Sharing

In preferred hub mode embodiments, the networking DSL modems 12, 14, 16 include software to achieve the resource sharing. For example, software in a networking DSL modem is able to identify packets from different sessions, and can assign sessions to customers. The software directs packets transmitted from customers over the shared DSL resources, and forwards packets received from an Internet connection and belonging to a session to the customer using a protocol. In a preferred embodiment, the device or software is implemented in a DSL modem, and in other exemplary embodiments it is implemented in a router, or an add-on device. Encryption may be provided by the device or software to protect customer sessions from other customers in the community. In other embodiments, DSL modem grants access to the shared DSL resources for its own data packets and the packets of other networking modems.

The idle capacity of the access line of a DSL customer can be used to support the data transfer requests of an active user in another residential unit. The DSL lines into junction boxes 41 and 84 are thus pooled together and shared, creating the capability for a residential unit customer to avail itself of the transmission capacity in all DSL lines if no other residential unit has a need to transfer data at a given time. Exemplary embodiments of the resource sharing will be discussed.

Data transfers in packet networks are often facilitated by session-oriented protocols. In particular, to realize communication between two endpoints, a session may first be initiated, whereby both endpoints communicate initially to synchronize state information for functions such as flow control and error control. This initial communication often takes the form of what is called a three-way handshake. Once both endpoints have synchronized state information, the flow of data can then take place. The transfer of session data packets realizes such data flow. Each session data packet is labeled with an identifier that determines the identity of the session. This identifier is typically determined during the initial state synchronization. Once the data transfer is completed, the end points then exchange control messages to terminate the session.

A TCP session, for example, is identified by an IP address and a port number associated with each endpoint. To initiate a session, TCP uses a three-way handshake, whereby special control packets called SYN packets are exchanged, which determine initial sequence numbers used for error recovery and flow control.

The embodiments to be discussed leverage a TCP session protocol for the directing of packets to and from customers in a wireless community. There are many existing session-oriented protocols in use in the Internet, such as TCP and RTP, and embodiments of the invention discussed below can operate with any such session-oriented protocol.

The networking modes 12, 14, 16 use the LAN data band or the legacy band (when used with the FIG. 6 switch mode junction to establish a Local Area Network (LAN) 40 for the limited purpose of DSL data transmission and reception. In an example embodiment, traffic is split across the DSL lines in the cable bundle 30 at the granularity of a TCP session. The networking modems 12, 14, 16 act as gateway proxy devices and achieve the sharing of the DSL resources in the cable bundle for all networking modems in an established resource sharing LAN.

The enhanced modems can act as a network of proxies to perform a load balancing function, attempting to spread the TCP session requests from all networking modems active in a LAN so that traffic is divided evenly across all of the wire pairs in the cable bundle 30. The proxies may utilize encryption in their joint communications as a way to provide security for communications of customers with respect to other customers in the community. In the switch mode, the local proxies are effectively implemented at the hub switch device and the DSL modems can be standard devices.

Consider a data transfer between a customer and a web server using a session-oriented protocol, which is initiated by the customer, which communicates with a networking modem. With the present invention, such a session may be altered, without modification of the protocols at the endpoints. In particular, a networking modem acts as a proxy to facilitate the data transfer. Another proxy, referred to as the remote proxy, also facilitates the data transfer. The remote proxy is another networking modem in the LAN. The invention alters the session in the following way. When a customer first initiates a communication with the web server, the local proxy residing inside the networking modem intercepts the packets associated with this communication and determines that a session initiation is taking place. The modem acting as a local proxy acts in accordance with how the web server would act, hence the name proxy. In particular, instead of the session taking place between a customer computer and a web server, the session takes place between the customer computer and the networking modem acting as a local proxy. In order to facilitate the data transfer, the local proxy selects another proxy, called a remote proxy. The remote proxy resides in another networking modem in the LAN.

The selection of the residential unit that contains the remote proxy can be made on the basis of the state of the LAN, past selection decisions, as well as on the basis of the pattern of recent activity. For example, the proxies may exchange state information. In an exemplary embodiment, a round robin approach is used for selection, and this and other scheduling algorithms may be used.

After a local proxy implemented by a networking modem intercepts the packet associated with the session initiation by a customer computer, the local proxy initiates a session with the remote proxy in the LAN established with the junction box 41 or the junction box 84. In turn, the remote proxy initiates a session with the web server.

The remote proxy forwards session data packets from the web server to the local proxy, which in turn forwards the session data packets to the customer computer. Similarly, in the other direction, the local proxy forwards session data packets from the customer computer, which in turn forwards the session data packets to the web server.

Artisans will note that the local and remote proxy need not independently generate protocol messages on behalf of the represented entity, and that the session between a local and remote proxy can be virtual. Rather, the local and remote proxies can simply forward session packets after applying a network address translation.

In other embodiments, the networking modems act only as local proxies, and a remote proxy server accessed at the central office 10 or over the Internet is established for the networking modems 12, 14, 15. A request made from a customer computer to initiate a TCP session with a device, e.g., a web server, is redirected by a local proxy to a remote proxy server that then makes TCP session requests on behalf of the customer computer that originally made the TCP session request. After the session is initiated, data packets from the session that originate at a web server are then transported to the proxy server, which forwards these data packets to the local proxy, which in turn forwards the packets to the customer computer that originally initiated the session. Similarly, after the session is initiated, data packets originating at the customer computer that initiated the TCP session are redirected by the local proxy to the proxy server. In turn, the proxy server forwards these session data packets to the web server that was the original target of the TCP session request.

Traffic can be divided across the wire pairs in the bundle 30 at the granularity of a packet, and thus the load can be evenly spread. The decision process for each packet that determines which residential access line will be used to transport the packet can be based on the state of the wireless network, the past history of decisions for other packets, as well as the current state of the residential access lines. The network of local proxies may exchange state information to facilitate this decision process. For example, the local proxies can use such state information to estimate the total load placed on each residential access line, and attempt to distribute load evenly among the residential access lines. The local proxies and the proxy server can also implement packet reordering, to increase the chances that packets will be transported end-to-end in the same order they were originally sent. The packet reordering can be implemented with sequence numbers that are inserted into the packets traveling between the proxy server and the local proxies. In addition, the local proxies and proxy server can provide encryption and decryption to each packet that travels between them, thereby alleviating the privacy concerns discussed earlier. In particular, data flowing across residential access lines as well as between residential units is encrypted, making Internet communications less susceptible to eavesdropping by neighbors. Packets originating from a computer inside a residential unit that are not recognized as belonging to a session are transported through the residential access line that terminates at the residential unit, and thus do not need to be transported via the wireless communication network.

To provide privacy, the proxy server can encrypt packets that are sent to a local proxy. When the packets reach the local proxy, the local proxy can decrypt the packets before forwarding them to a customer computer. In the reverse direction, the local proxy can encrypt the packets that are sent to the proxy server. When the packets reach the proxy server, the proxy server can decrypt packets before forwarding them to the web server.

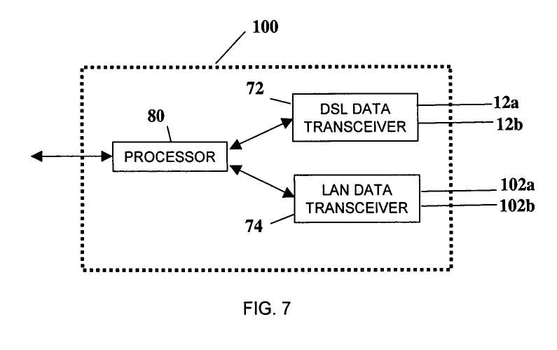

FIG. 7 shows an additional embodiment DSL modem 100 that can be used with the hub mode. In this case, no filters need to be added to the junction box. Instead, spare wires from the junction box are used to form separate connections for a LAN network of enhanced DSL modems. The modem 100 of FIG. 7 includes a DSL data transceiver 72 and a LAN data transceiver 74, and a processor 80. The processor 80 controls the DSL data transceiver 72 and the LAN data transceiver 74 to achieve DSL resource sharing with other resource sharing devices in a common LAN established by a common junction box. The LAN makes use of additional wire pair 102a, 102b, available from the junction box, such as “spare wires” that are sometimes available, or additional wires that can be added.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims

1. In a digital subscriber line (DSL) communication system including a central office connected to customer DSL modems over telephone lines, a resource sharing device, the device comprising:
junction means providing aggregated communication channels to enable resource sharing of a plurality of customer telephone lines for resource sharing;
connectors to connect said junction means to a plurality of customer premises.

2. The resource sharing device of claim 1, wherein said junction means comprises filter means for establishing a network communication channel in a higher frequency band separate from legacy voice and data frequency bands.

3. The resource sharing device of claim 2, wherein said junction means comprises:
transceiver means for establishing a network communication channel using higher data rates than legacy data transmission data rates; and
a processor to coordinate legacy data communications with the central office at the legacy data transmission data rates and data and network communications with customer DSL modems at the higher data rates.

4. In a digital subscriber line (DSL) communication system including a central office connected to customer premises over telephone lines, a resource sharing device, the device comprising:
a DSL data transceiver operating in a legacy DSL frequency band;
a LAN data transceiver operating in a LAN frequency band at higher frequency than the legacy DSL frequency band;
a LAN band pass filter;
a DSL band pass filter;
a processor that controls said DSL data transceiver and said LAN data transceiver and for using the LAN data transceiver to achieve DSL resource sharing with other resource sharing devices in a common LAN established by a junction box.

5. In a digital subscriber line (DSL) communication system including a central office connected to customer premises over telephone lines, a resource sharing method comprising:
establishing a LAN network through a junction box shared by a plurality of customer premises;
using LAN communications to coordinate sharing of DSL resources provided from a central office to the junction box;
sharing DSL data bandwidth provided to the junction box from the central office.

6. The method of claim 5, wherein said step of establishing comprises communicating on a LAN frequency band that is higher than legacy voice and data bands.

7. The method of claim 5, wherein said step of establishing comprises communicating at LAN communication data rates that are higher than legacy data communication data rates.

8. The method of claim 5, wherein said step of establishing comprises communicating over spare twisted pair wires between the customer premises and the junction box.

9. In a digital subscriber line (DSL) communication system including a central office connected to customer premises over telephone lines, a resource sharing device, the device comprising:
a DSL data transceiver;
a LAN data transceiver;
a processor that controls said DSL data transceiver and said LAN data transceiver and for using the LAN data transceiver to achieve DSL resource sharing with other resource sharing devices in a common LAN established by a junction box.
